(19) United States
(12) Patent Application Publication
(10) Pub. No.: US 2001/0040326 A1
(43) Pub. Date: Nov. 15, 2001

(54) RESILIENT MEMBER WITH DEFORMED ELEMENT AND METHOD OF FORMING SAME

(75) Inventors: PAUL J. BALCZUN, ERIE, PA (US); GERARD M. ORINKO, ERIE, PA (US)

Correspondence Address: RANDALL S WAYLAND, LORD CORPORATION, P O BOX 8012, CARY, NC, 275128012

(73) Assignee: LORD CORPORATION

(21) Appl. No.: 09/332,483

(22) Filed: Jun. 14, 1999

(51) Int. Cl. F16M 1/00

(52) U.S. Cl. 267/141

(57) ABSTRACT

A resilient member and method of forming the same wherein the resilient member isolates the transmission of vibrations and/or sound. The resilient member (20) includes a first element (24), preferably including a contour (26), a second element (28) manufactured from a deformable material (e.g., a thermoplastic), and a resilient element (32) (e.g., rubber). The second element (28) is deformed during a molding process to conform its shape or size to the surface (25) of the first element (24). In a preferred embodiment, the second element (28) is plastically deformed to conform to a contour (26) of the first element (24) thereby forming a mechanical interlock. Rotational and translational interlocks and the method for forming same are described.

### FIELD OF THE INVENTION

The present invention is directed to the field of devices including resilient materials, such as elastomer bearings, mounts, dampers and rod ends. More particularly, this invention is directed to an improved resilient member to provide isolation of transmitted vibrations or to accommodate motion.

### BACKGROUND OF THE INVENTION

Elastomer rod ends, that is, rod ends including elastomer joints, are widely used to make various connections, and are generally used with linkages or cables. Such rod ends 1 as illustrated in Prior Art FIGS. 1 and 2 are typically comprised of a rigid outer element housing 2, a plastic inner sleeve 3, a resilient elastomer element 4, and a rigid metal inner element 5. The outer element housing 2 includes a body portion 6 with a cross-wise formed opening 7 and a threaded element 8 extending radially from the body portion. The resilient elastomer element 4 is vulcanized bonded to the outer surface of the inner sleeve 5, and collectively comprises a bonded joint 9 which is received in unbonded contact in the opening 7. The inner sleeve 3 is cylindrically shaped and slides against the inner element 5 and provides some level of rotation accommodation by allowing relative slippage between the sleeve 3 and inner element 5. The rod end 1 may be bolted to a bracket or other connector and the pivotability of the bonded joint 9 permits misalignment and movement of the housing 2 relative to the connector, as needed. The elastomer 4 also provides a vibration blocking path such that noise and vibration transmission may be minimized through the rod end 1. Thus, such resilient rod ends 1 are useful in reducing vibration transmitted to gear shifting and other mechanisms thereby isolating the user or equipment from vibration.

A particular problem of the prior art rod ends 1 is that the inner element 5 is attempted to be pressed into the inner sleeve 3 with a light press fit such that the elements 3, 5 are lightly retained together prior to assembly. The light press fit is desired to keep the inner element 5 from falling out of the sleeve 3, yet does not appreciably affect relative rotation therebetween. It should be recognized that it is desirable that the fit used should not be so tight as to provide any significant rotational restraint between the elements. Of course, such press fits are subject to the tolerances caused by the manufacturing processes used to make them. As such, some press fits are very heavy thereby resulting in undesirable resistance to rotation between the inner element 5 and sleeve 3, and, in the extreme, may cause cracking of the plastic sleeve 3. Contrarily, under some tolerance stackup conditions, a too slight or no press fit situation occurs, thereby leading to the inner element 5 undesirably falling out of the inner sleeve 3. Furthermore, if the fit is very loose, this causes undesirable slop in the connection that may cause rattling in use. Therefore a need exists for a cost-effective method to retain the inner element within the plastic sleeve, as well as a method to provide an excellent fit between the members.

### SUMMARY OF THE INVENTION

In accordance with the invention, a resilient member and method of forming the same is provided. According to a first embodiment, a resilient member is provided wherein during molding of a resilient element, a second element plastically deforms to generally conform to a first surface of a first member. Accordingly, an excellent (near line-to-line) fit between the first and second elements of the resilient member may be achieved. This may improve service life of the member and helps retain the first member relative to the second member.

According to the first embodiment, and in more detail, a resilient member is provided comprising a first element with a first surface; a second element of deformable material which abuts the first element and which has a second surface adjacent to the first surface and a third surface on an opposite side of the second element from the first surface; and a resilient element adjacent to the third surface wherein during molding of the resilient element, the second element plastically deforms to generally conform to the first surface. The deformation may be is size, shape or both.

According to the invention the resilient member may also include mechanical interlock, whereby the deformable second element deforms during molding to conform to a contoured first element. This forms the interlock that retains the first element relative to the second in a preferred direction. In particular, during the molding process, temperature and/or pressure acts on a resilient element and forces it into contact with the deformable second element thereby plastically deforming it. Accordingly, the second element may conform to the shape or size of the first element thereby permanently restraining relative motion between them (locking one to the other) in at least one direction (e.g., rotation or translation).

Further, and in accordance with the invention, a resilient member is provided comprising a first element having first surface with a contour formed thereon; a second element abutting the first element and having a second surface which is received adjacent to the contour, and a third surface on an opposite side of the second element from the first surface, the second element comprising a deformable material (e.g., thermoplastic material); and a resilient element (e.g., an elastomer or other rubber-like resilient material) disposed adjacent to the third surface of the second element wherein during the molding of the resilient member, the second element plastically deforms to conform to the contour and resultantly prevent motion of the first element with respect to the second element in a first direction.

The contour may comprise many shapes, such as a groove which is preferably centrally located along a length of the first element, a non-round profile formed on at least a portion of the first element such as at least one flat portion, a projection extending from the first element, dimples formed on the first element, a recess formed in the first element, or other like protrusions or impressions.

In one illustrated embodiment, the first direction comprises a translation whereas in another, the first direction comprises a rotation. In the specific embodiment where the first direction comprises a rotation, the first element is restrained torsionally, but is free to slide axially relative to the second element. In the other embodiment where the first direction comprises a translation, the first element is restrained axially, but is free to rotate relative to the second element.

The first surface on which the contour is formed may be and interior or exterior surface of the first element. In a preferred embodiment, a third element is provided which abuts the resilient element. The third element, for example, may comprise a rod end including a body portion and a threaded element extending therefrom or a hollow, generally cylindrical member. The resilient element may be bonded or unbonded to the third element.

In accordance with another aspect of the invention, a method of forming a resilient member is provided comprising the steps of: inserting a first element including a first surface into a mold; providing a second element of deformable material in the mold adjacent to the first element, the second element including a second surface positioned adjacent to the first surface, and a third surface on an opposite side of the second element from the second surface; and forming in a molding process, a resilient element adjacent to the third surface wherein during the molding of the resilient element the second element plastically deforms to conform to the first surface of the first element. Accordingly, the first member may be provided with a contour, and the plastic deforming of the second element may conform to the contour of the first element during the molding wherein relative motion of the first element with respect to the second is restrained in a first direction.

It should be recognized that the present invention may be employed to improve the fit between the first and second element or to retain the elements relative to each other in a first direction, or both.

It is an advantage of the present invention that it provides a cost-effective method of providing a mechanical interlock feature.

It is an advantage of the present invention that it provides rotational or axial slippage between elements thereby providing an excellent bearing function.

It is a further advantage of the present invention that it provides a bearing that has a near perfect line-to-line fit, i.e., a very close tolerance fit between the elements.

Various other features, advantages and characteristics of the present invention will become apparent after a reading of the following detailed description of the preferred embodiments.

### BRIEF DESCRIPTION OF THE DRAWINGS

The present invention is described in conjunction with the following figures, where like reference numerals describe like parts, in which

FIG. 1 is frontal view of a Prior Art resilient rod end bearing;

FIG. 2 is a side cross sectional view of the Prior Art rod end taken along line 2-2 of FIG. 1;

FIG. 3 is frontal view of a resilient rod end bearing including the invention resilient member;

FIG. 4 is a side cross sectional view of the first embodiment of a rod end bearing including the invention taken along line 4-4 of FIG. 3;

FIG. 5 is frontal view of a bonded joint of the bearing of FIG. 3;

FIG. 6 is a cross sectional side view of the bonded joint taken along line 6-6 of FIG. 5; and

FIG. 7 is a perspective view of an embodiment of inner element including a retention groove contour;

FIG. 8 is a cross sectional side view of a mold prior to transfer of the elastomer;

FIG. 9 is a cross sectional side view of the mold of FIG. 8 subsequent to transfer of the elastomer illustrating the deformed second element;

FIG. 10 is a cross sectional side view of another embodiment of the present invention resilient member;

FIG. 11 is a cross sectional end view of another embodiment of the present invention;

FIG. 12-13 are cross sectional side views of other embodiments of the present invention; and

FIG. 14-15 are partial cross sectional side views of other embodiments of the present invention.

### DETAILED DESCRIPTION OF THE PREFERRED EMBODIMENTS

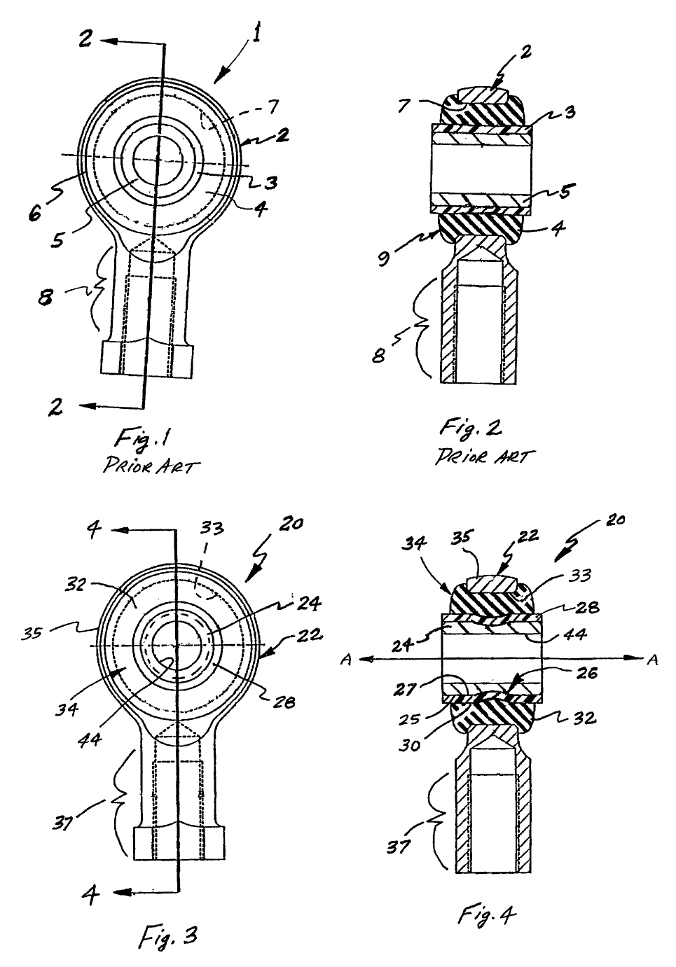

A first embodiment of the present invention is shown in FIGS. 3-4. The invention is illustrated in the embodiment of an elastomer rod end, but from the following it should be understood that the present invention is useful in a wide variety of bearings, dampers, mountings, and isolators. The invention is useful for providing permanent retention of one element relative to another element, where desired. Moreover, the invention provides a method for cost-effectively obtaining a near perfect line-to-line fit between the elements where an excellent bearing function is desired.

The resilient member 20 according to the invention is shown embodied in a rod end that includes a rigid first element 24 such as an inner element, a deformable second element 28 such as the thermoplastic generally cylindrical sleeve shown, and a resilient element 32 such as an elastomer or other rubber-like resilient material abutting the second element. A third element 22, such as the rigid rod end housing shown, may be disposed in contact with the resilient element 32, and may be optionally bonded thereto. In the illustrated rod end embodiment, the housing 22 comprises a body portion 35 having a threaded element 37 extending therefrom and a cross-wise formed recess 33.

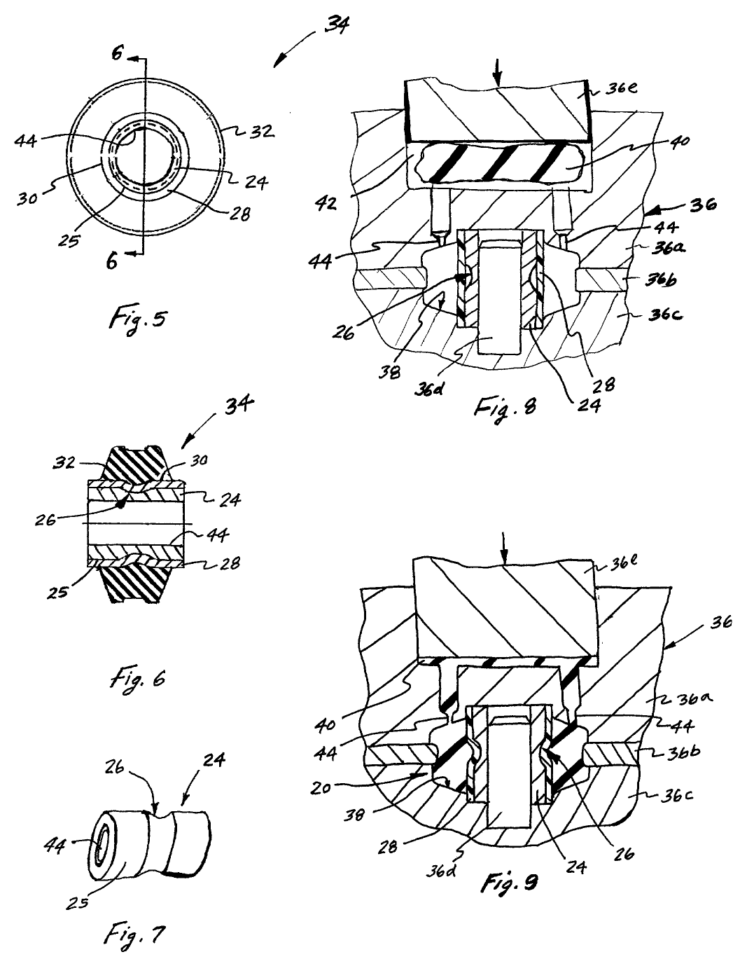

According to the embodiment of FIG. 3-4, the resilient member 20 comprises a bonded joint 34 (FIG. 5-6) which is received in the recess 33 formed in the body 35 of the third element 22. The mechanical interlock formed according to the invention, as illustrated in FIGS. 3-5, restrains axial motion along a first direction (along the axis A-A), yet desirably allows generally unrestrained rotation in a second direction (pivoting about the axis A-A). Thus, the invention is useful for any isolated pin joint where axial motion, for example, is to be restrained between the members and rotational motion is to be freely accommodated. Moreover, it should be recognized, such pivotal motions are allowed with an excellent line-to-line fit between the elements thereby minimizing the propensity for the elements of the joint to fatigue, i.e., pound out, during use.

The excellent line-to-line fit is provided in accordance with the invention during molding when the second element 28 is deformed into close contact with the first element 24. In short, by plastically deforming the second element 28, it conforms to the first surface 25 of the first member 24. Upon removal of the pressure and temperature after molding, a close tolerance fit is achieved between the members 24, 28. This line-to-lien fit achieving aspect of the invention may be employed by itself or in combination with deforming to a contour 26 formed on the first member 24 if further retention is desired in and first direction.

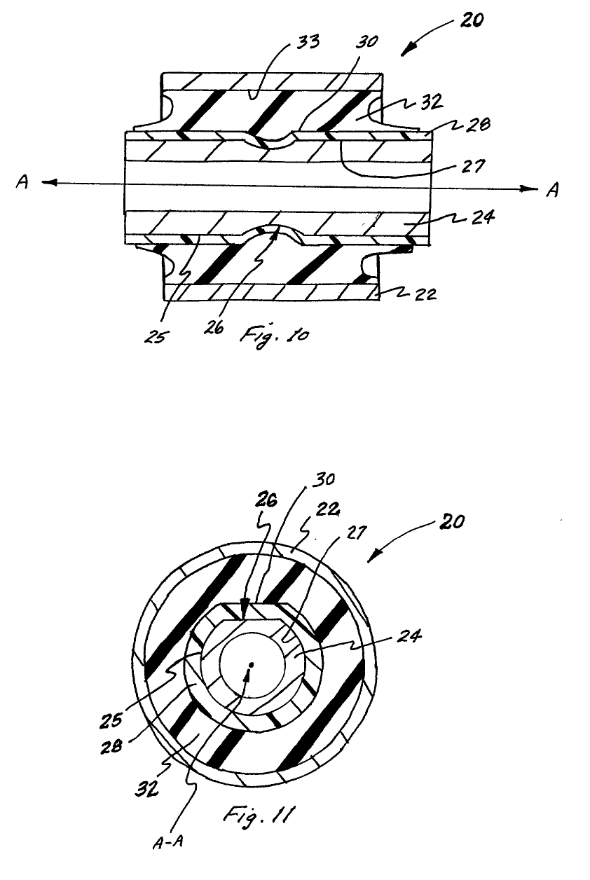

The bonded joint 34, as best shown in FIGS. 5 and 6, is comprised of the first generally cylindrical element 24 (FIG. 7), the generally cylindrical second element 28, and a generally annular resilient element 32. In a preferred embodiment, the first element 24 includes a through bore 44 which receives a bolt (not shown) for attaching the first (inner) element 24 to a supporting or supported structure (not shown). For example, the bolt may attach to a shift mechanism and the treaded element 37 of the housing 22 (FIG. 4) may attach to a linkage or cable. The resilient element 32 may be of any desired shape, modulus or spring rate required for the application and is preferably formed of an elastomer or rubber-like resilient material, preferably highly incompressible material, such as, for example, a natural rubber, nitrile, neoprene, silicone, urethane, fluorocarbon elastomer, EPDM, SBR, PBR, or other synthetic elastomers or blends thereof.

By the term “deformable,” as used herein, it should be understood that the second element 28 is manufactured from a material that may be plastically deformed in shape and/or size during a molding process (most preferably a thermoplastic material). Preferably, the material also exhibits good bearing qualities with low wear and low friction characteristics. One preferable material is Nylon. More preferably, Nylatron (with molydisulfide added), for example, NY GS 51 may be used. Alternatively, a thinwalled, soft brass or bronze metal or, if sufficient pressure is available, then an aluminum or an annealed steel may be used. According to the invention, when a thermoplastic material is used, the second element sleeve 28 may preferably be about 1-2 mm thick and should be close to the size of the first element 24 as practical such that the amount of deformation required to achieve the line-to-line fit or interlock is minimized. Standard mold temperatures and pressures commonly used are adequate to deform the sleeve 28.

In the illustrated embodiments of FIGS. 4-6 and FIGS. 10-15, one of the first 24 or second 28 elements preferably includes a contour 26 comprising a projection, a groove, a recess, one or more dimples, or other like interference structure. During the transfer, injection, or compression bonding process, depending on that which is used (all referred to herein as “molding” or the “molding process”), uncured resilient material is provided adjacent to the contact surface 30 of the second element sleeve 28. Under heat and/or pressure, the material of sleeve 28 plastically deforms to conform to, or closely conform to, the configuration of the first surface 25 of the first element 24 to which it abuts. This may be a plastic deformation of its shape, size, or both. In essence, the deformable material conforms to the shape and/or size of a first surface 25 of the abutting first element 24. It should be recognized that, although desired, a complete deformation of shape may not be required for providing some level of retention.

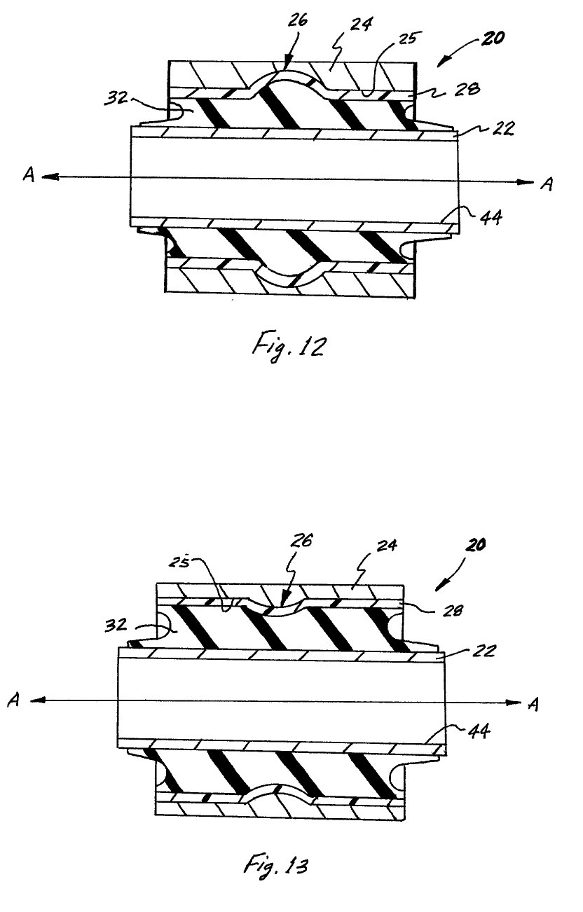

When the molding process is complete, the resilient element 32 has become vulcanized bonded to the sleeve 28 and may also be vulcanized bonded to the other elements (see, for example the outer members 22 of FIGS. 10-15). Through deformation of the second element 28 during the molding process, the line-to-line fit and/or mechanical interlock in accordance with the invention is formed between the first 24 and second 28 elements.

In the case of the FIG. 3 and 4 embodiment, the mechanical interlock is formed when the bonded joint 34 is molded (FIGS. 5-7). The bonded joint 34 including the invention is formed as best shown in FIG. 8 by a conventional transfer molding process. The mold 36 including multiple mold portions 36-36e includes a mold cavity 38 that has the first 24 and second 28 elements inserted therein. First element 24 is received over mold pin 36d and the cylindrical second element 28 is received over it. Plastic second element 28 preferably includes a suitable adhesive, such as Chemlok 254 available from Lord Corporation or Erie, Pa., adhered to its outer surface 30. The mold portions 36a-b are installed, as is known to those of ordinary skill in the art, and a pig of uncured elastomer 40 is placed in the mold's transfer pot 42. The piston 36e is traversed into the transfer pot 42 and the elastomer pig 40 (under heat and pressure) is forced through sprues 44 and into the mold cavity 38.

As the cavity 38 fills with elastomer and temperature and pressure is applied to the pig 40 and mold 36, the pressure acts on the third surface 30 of the second element 28 and “plastically deforms” it to conform to the surface 25 or contour 26 formed on the first element 24. The term “plastically deforms” means that the second element 28 deforms from its original shape or size and upon removal of the heat and/or pressure, it remains deformed to some extent and does not return to its original shape or size. Of course, the applied heat also helps to deform the material of the second element 28.

As shown in FIG. 7, a contour 26, in the form of a centrally positioned groove, is formed in the outer surface 25 of the first element 24. In accordance with the preferred embodiment, upon being deformed, the second element 28 closely conforms to the contour 26 and surface 25 formed on the first element 24 such that a tight toleranced or line-to-line fit is provided, as best illustrated in FIG. 9. The resilient member 20 is then removed from the mold via breaking the sprues. The resilient member 20, in the form of bonded joint 34 (FIGS. 5-6), is then installed in the housing of FIG. 3, 4 to form the completed rod end with the retained inner element 24 and including a line-to-line fit between the elements 24, 28.

The term “molding” as used herein is meant to encompass transfer, injection, and compression and other similar conventional molding processes known to those of ordinary skill in the art. It should be understood that the invention is applicable regardless of the molding process used. The invention finds utility for forming a mechanical restraint or interlock between elements and/or a line-to-line fit where a resilient material is employed in a molding process and the pressure and/or temperature of the process causes pressures in the resilient material which deforms one deformable element onto another element thereby causing the second element to permanently take on a new size or shape. It should be appreciated that the second element 28 may take on a variety of initial shapes as desired for the application, such as conical.

FIG. 10 illustrates a tubeform mounting comprising the resilient member 20. This embodiment is similar to that of FIGS. 3 and 4 except that the third element 22 comprises a cylindrical tube rather than a rod end housing and the resilient element 32 is vulcanized bonded to the interior surface 33 of the third element 22 during the molding process. In use, the mounting's third element 22 would interconnect to a first one of a supported or supporting member (neither shown). For example, it may be received in a pocket. The first element 24 would interconnect to the other one of the supported or supporting members, for example, by a bolt. Again, the second element 28 is deformed to conform to the contour 26 (groove) formed in the first element 24 and preferably results in a close or line-fit relationship.

FIG. 11 illustrates a tubeform mounting comprising the resilient member 20 similar to FIG. 10 except that the mechanical interlock formed between the elements 24, 28, in this case, restrains rotation of the first element 24 relative to the second element 28 about the axial axis A-A (shown as a dot). During molding, the second element 28 has an initial cylindrical shape as shown in FIG. 8. As in all the illustrated embodiments herein, upon molding, the mold heat raises the temperature of the thermoplastic material of the second element 28 above its glass transition temperature and/or the pressure acts on the outer surface 30 of the second element 28 sufficiently to cause it to deform into the general shape of the first element 24 which includes the contour 26 formed thereon.

In this embodiment, the contour 26 comprises a non-round profile, such as a flat formed along a portion or the entire axial length of the first element 24. Under such heat and pressure, the second element 28 deforms and comforms to the shape of the first element 24 thereby providing a rotational restraint between the elements 24, 28. If the flat contour 26 extends along the entire length of the first element 24, then it should be recognized that the first element 24 may side axially (along axis A-A) relative to the second element 28, which may be desirable for some applications. It should also be understood that a number of different shapes may be imparted to the outer surface 30 of the first element 24, such as square, octagon, hexagon, etc. to provide the anti-rotation interlock feature upon molding and conforming of the second element 28 to such a shape.

FIGS. 12-15 illustrate several other embodiments of resilient members 20 wherein an axial interlock is formed by deforming the second element 28 to conform to the shape of a first element 24. In these embodiments as in the previous ones, the second element 28 initially comprises a cylindrically-shaped sleeve (as shown in FIG. 8) before molding and thereafter conforms to the shape or size of the first element 24. In each embodiment of FIGS. 12-15, the first element 24 comprises an outer element, such as the generally cylindrical element shown having a contour 26 formed thereon. In each embodiment, the mounting may also include a tubular inner element as the third element 22 having a bore 44 for attachment to one of a supporting and supported member (not shown).

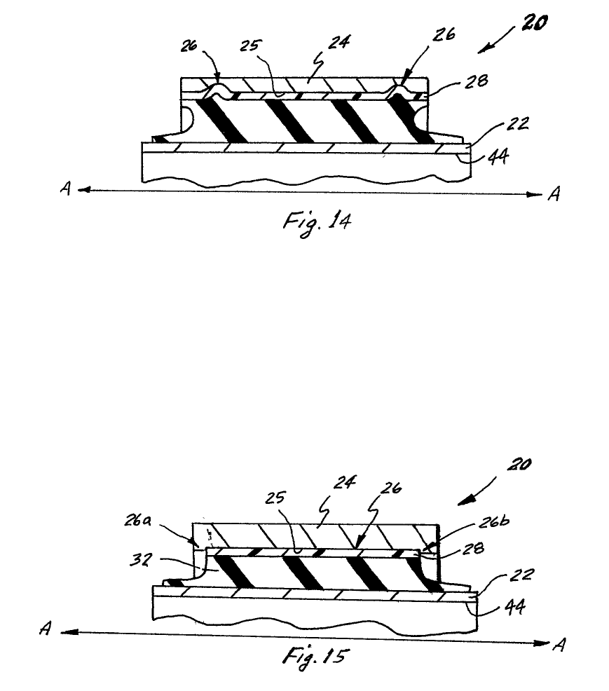

The contours 26 may take on a variety of different shapes or forms. For example, in FIG. 12, the contour 26 may be a centrally located groove formed in the first (interior) surface 25 of the first element 24. In FIG. 13, the contour 26 comprises a centrally positioned projection extending radially inward from a first (interior) surface 25 of the first element 24. In FIG. 14, for example, the contour 26 comprises a plurality of grooves formed in the first (interior) surface 25 first element 24. In the FIG. 15 embodiment, the contour 26 comprises a wide, slightly-recessed groove. In this last embodiment, when heat and/or pressure is applied during molding, the cylindrical sleeve 28 is deformed in size (diameter of the sleeve 28) such that it conforms to the largest diameter of the interior surface 25, i.e., the bottom of the groove 26. The small degree of overlap provided after molding at the ends 26a, 26b of the first element 24 then retains the second element 28 from axial movement along axis A-A while retaining the ability for the sleeve 28 to rotate relative to the first (outer) element 24. Other types of contours may be provided, such as dimples, v-grooves, diverging tapers, and the like.

Various changes, alternatives and modifications will become apparent to a person of ordinary skill in the art following a reading of the foregoing detailed description. It is intended that all such changes, alternatives and modifications that fall within the scope of the appending claims be considered part of the present invention. For example, contour shapes other than those described herein may be employed.

What is claimed is:

1. A resilient member, comprising:
a) a first element including a first surface;
b) a second element comprising a deformable material and abutting the first element and having a second surface which is received adjacent to the first surface and a third surface on an opposite side of the second element from the first surface; and
c) a resilient element disposed adjacent to the third surface of the second element wherein during the molding of the resilient element, the second element plastically deforms to conform to the first surface.

2. The resilient member of claim 1 wherein the first surface includes a contour and during molding, the second element plastically deforms to conform to the contour and resultantly prevent motion of the first element with respect to the second element in a first direction.

3. The resilient member of claim 2 wherein the contour comprises a groove.

4. The resilient member of claim 3 wherein the groove is substantially centrally located along a length of the first element.

5. The resilient member of claim 2 wherein the contour comprises a non-round profile formed on at least a portion of the first element.

6. The resilient member of claim 5 further comprising at least one flat portion.

7. The resilient member of claim 2 wherein the contour comprises a projection extending from the first element.

8. The resilient member of claim 2 wherein the contour comprises a recess formed in the first element.

9. The resilient member of claim 2 wherein the first element is restrained torsionally in the first direction yet is free to slide axially relative to the second element.

10. The resilient member of claim 2 wherein the first surface comprises an exterior surface of the first element.

11. The resilient member of claim 2 wherein the first surface comprises an interior surface of the first element.

12. The resilient member of claim 2 wherein the first direction comprises a translation.

13. The resilient member of claim 12 wherein the second element is free to rotate in a second direction.

14. The resilient member of claim 2 wherein the first direction comprises a rotation.

15. The resilient member of claim 14 wherein the second element is free to slide in a second direction.

16. The resilient member of claim 2 wherein the second element is manufactured from a thermoplastic material.

17. The resilient member of claim 1 further including a third element abutting the resilient element.

18. The resilient member of claim 17 wherein the third element comprises a rod end including a body portion and a threaded element extending therefrom.

19. The resilient member of claim 1 wherein the deformation causes a permanent change in a shape of the second element.

20. The resilient member of claim 1 wherein the deformation causes a permanent change in a size of the second element.

21. The resilient member of claim 1 wherein the deformation causes a permanent change in a diameter of the second element.

22. The resilient member of claim 1 wherein the resilient element comprises an annulus.

23. The resilient member of claim 1 wherein the deformation causes a substantial line-to-line fit between the first and second elements.

24. A resilient member, comprising:
a) a first generally cylindrical element including a first surface with a contour formed thereon;
b) a second cylindrical sleeve element abutting the first element and having a second surface which is received adjacent to the contour and a third surface on an opposite side of the second element from the first surface, the second element comprising a deformable material; and
c) an annular resilient element disposed adjacent to a third surface of the second element wherein during the molding of the resilient element, the second element plastically deforms to generally conform to the contour and resultantly prevent motion of the first element with respect to the second element in an axial direction.

25. A resilient member, comprising:
a) a first element including a first surface having a contour formed thereon;
b) a second element, formed of a deformable material, abutting the first element, and having a second surface received adjacent to the contour, and a third surface on an opposite side of the second element from the first surface;
c) a resilient element disposed adjacent to the third surface of the second element wherein during the molding of the resilient element, the second element plastically deforms to substantially conform to the contour and resultantly prevent motion of the first element with respect to the second element in a first direction; and
d) a third element which receives the resilient element adjacent thereto.

26. A resilient rod end, comprising:
a) a first element including a first surface with a contour formed thereon;
b) a second element, formed of a deformable material, abutting the first element, and having a second surface received adjacent to the contour, and a third surface on an opposite side of the second element from the first surface;
c) an annular resilient element disposed adjacent to the third surface of the second element wherein during the molding of the resilient element, the second element plastically deforms to conform to the contour and resultantly prevents motion of the first element with respect to the second element in an axial direction yet allow rotation; and
d) a third element including a body portion with a threaded portion extending therefrom, and a crosswise formed bore formed in the body portion which receives the resilient element therein.

27. A method of forming a resilient member, comprising the steps of:
a) inserting a first element including a first surface in a mold;
b) providing a second element of deformable material in the mold adjacent to the first element, the second element including a second surface adjacent to the first surface and a third surface on an opposite side of the second element from the second surface, and
c) forming in a molding process, a resilient element adjacent to the third surface of the second element, wherein during the molding of the resilient element, the second element plastically deforms to conform to the first surface of the first element.

28. The method of forming a resilient member of claim 27 further comprising the additional steps of:
d) providing the first element with a contour, and
e) plastically deforming the second element to conform to the contour of the first element during the molding process wherein relative motion of the first element with respect to the second element is restrained in a first direction.
